(19) United States
(12) Patent Application Publication
(10) Pub. No.: US 2008/0298048 A1
(43) Pub. Date: Dec. 4, 2008

(54) HEADLAMP WITH DETACHABLE LED FLASHLIGHT

(75) Inventors: Kevin S. Garrity, Madison, CT (US); James Sener, Madison, CT (US)

Correspondence Address: FITZPATRICK CELLA HARPER & SCINTO, 30 ROCKEFELLER PLAZA, NEW YORK, NY, 10112, US

(73) Assignee: Garrity Industries, Inc., Madison, CT (US)

(21) Appl. No.: 11/757,062

(22) Filed: Jun. 1, 2007

(51) Int. Cl. F21V 21/084

(52) U.S. Cl. 362/105

(57) ABSTRACT

The present invention relates to a headlamp having a detachable LED flashlight and having a strap and a main body made of a flexible material and is designed to fit easily and comfortably over a user's head. The main body of the headlamp has a housing with a cavity formed therein, and the detachable flashlight is configured to have a snug-fit in the cavity. The flashlight comprises a body and a cap, the cap being attached to the body by a flexible strap. The body of the flashlight has a battery compartment and a circuit board.

### BACKGROUND OF THE INVENTION

1. Field of the Invention

The present invention relates to a portable lighting device. More particularly, to a headlamp with a detachable LED flashlight.

2. Description of the Related Art

[Lighting devices mounted on headbands are useful in that hands-free illumination is possible. U.S. Pat. No. 6,848,804 shows an example of a lighting apparatus attachable to a person's head. U.S. Pat. No. D470,615 S to Janice et al., entitled “Personal Headlamp,” U.S. Pat. No. D472,998 S to Paris et al., entitled “Lighting Device,” U.S. Pat. No. D506,846 to Kang et al., entitled “Head Lamp,” and U.S. Pat. No. D531,335 S to Garrity, entitled “Headlamp,” also show examples of lighting devices mounted on headbands.

Prior devices, like those identified above, generally differ in that the lighting device is not easily removable or removable at all from the headband.

U.S. Patent Publication Number US 2004/0145887 to Huang discloses a headband with a detachable illumination assembly light. A front well is formed in the headband for receiving a battery compartment. The battery compartment is shaped to conform to the well and is detachably attached thereto by a magnet. Only the battery compartment fits in the well, and the illumination assembly protrudes significantly from the headband.

Also, U.S. Pat. No. 6,575,587 to Cramer et al. discloses a lamp that clamps onto different locations on a user's body, including onto a headband. The lamp is connected to a power supply, such as a battery pack or AC adapter, by a cord.

The detachable illumination assemblies taught by these references, however, have one or more of the following disadvantages. First, the lighting devices substantially protrude from the headband, adding to the bulk of the overall headband. Furthermore, because the lighting device is only secured to the headband by a magnet (in the case of Huang) or by a clamp (in the case of Cramer et al.), the flashlight can inadvertently become detached, and therefore, the apparatuses are not conducive to activities in which a user is active. Cords also add unnecessary bulk and increase the risk of the lighting device getting caught on a foreign object and becoming inadvertently detached. In some of these prior art devices, the lighting device is not easily detachable, and thus the flashlight cannot be readily used without the headband.

These references also do not disclose housings for enclosing the lighting device. The lighting devices are thus generally exposed and are susceptible to inadvertent removal and exposure to outside elements.

For the foregoing reasons, there is a need for a headlamp with a detachable flashlight, in which a housing is formed in a main body of the headlamp and the flashlight is secured in the housing, yet is easily removable and fully operable without the headband.

### SUMMARY OF THE INVENTION

The present invention is thus directed to a headlamp comprising a strap, a main body having a housing with a cavity formed therein, and a detachable flashlight, formed to fit in the cavity of the housing, wherein a rear opening is formed on an inside face of the main body for insertion of the detachable flashlight into the housing, and the flashlight is at least partially held in place by a user's head when the headlamp is being worn.

According to one aspect of the present invention, the housing is designed so that the flashlight is snugly received in the cavity of the housing. Preferably, the cavity of the housing and the flashlight are designed such that the flashlight can be snap-fit into the housing. The cavity and flashlight are preferably tapered so that when the flashlight is inserted in the cavity, it abuts with a narrower front opening to prevent the flashlight from slipping out of the cavity and to secure it therein. Once the flashlight is inserted into the cavity of the housing and placed over a user's head, the user's head presses against a rear portion of the flashlight and keeps the flashlight from becoming inadvertently detached.

According to a one aspect of the present invention, the flashlight comprises at least one light emitting diode (LED). The flashlight also has a dimming function, controlled by a switch. The flashlight generally comprises a body and a cap, with a strap that connects the two. The body of the flashlight houses a circuit board and has a battery compartment for the batteries.

According to another aspect of the present invention, the main body is generally made of a flexible material, and is lined with a material more rigid than the flexible material to give the cavity additional structure. The cavity has a plurality of openings to accommodate various parts of the flashlight, for example, the switch.

According to another aspect of the present invention, the cavity of the housing and the flashlight each have at least one of various protrusions, recesses, wings, lips, flanges, rims, projections, and the like, that allow the flashlight to snap fit in the cavity of the housing. Yet use of a flexible material for the main body allows a user to manipulate the flexible cavity to release the flashlight therefrom.

According to another aspect of the present invention, the flashlight is at least partially held in place by a user's forehead. That is, the rear opening of the cavity faces an internal portion of the headband, such that, when the user wears the headlamp, it is held in place by a portion of the user's head. According to another aspect of the present invention, the flashlight is not removable when worn on the user's head.

Further features of the present invention will become apparent from the following description of exemplary embodiments with reference to the attached drawings.

### BRIEF DESCRIPTION OF THE DRAWINGS

FIG. 1 is a perspective frontal view showing the headlamp according to an embodiment of the present invention;

FIG. 2 is a partially exploded rear view showing the headlamp of FIG. 1 with the detachable flashlight removed from the headlamp;

FIG. 3 is a perspective rear view of the detachable flashlight of the headlamp of FIG. 1 with the cap removed from the body; and

FIG. 4 is a perspective rear view showing the headlamp of FIG. 1.

### DESCRIPTION OF THE EMBODIMENTS

Preferred embodiments of the present invention will be described below with reference to the accompanying drawings.

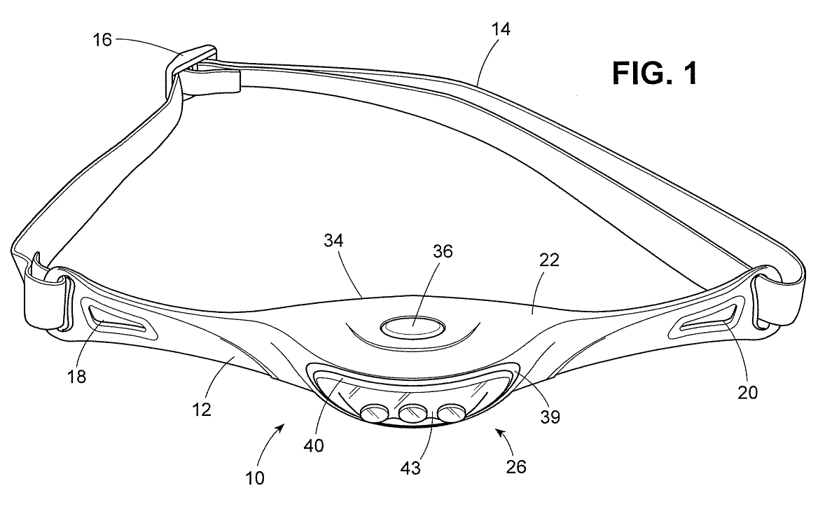

FIG. 1 is a perspective frontal view showing the headlamp with a detachable flashlight according to one embodiment of the present invention. A headlamp 10 shown in FIG. 1 has a main body 12 and a strap 14. The main body and strap of the headlamp are preferably flexible or elastic, so that the headlamp can easily be placed over a user's head. With the strap 14 being elastic, a user can put on the headlamp without any additional fasteners, and this enables the headlamp to be worn on a users head regardless of its shape or size. The strap 14 may also have an adjustment loop 16 for adjusting the length of the strap. Preferably, the main body 12 is made of a flexible plastic, or alternatively, by other suitable materials with elastic properties. In other embodiments, portions of the main body can be made of semi-rigid materials to give certain flexible portions of the main body additional structure. The main body 12 can also have vents 18 and 20 on the sides thereof to allow for ventilation.

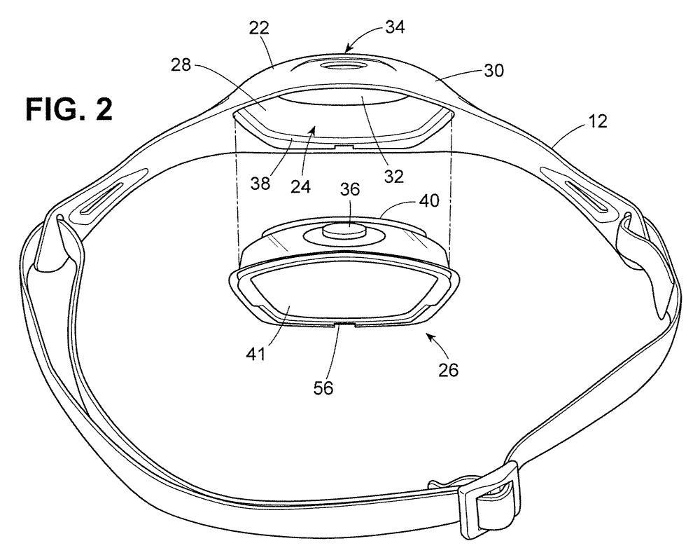

As shown in FIG. 2, the main body 12 of the headlamp has a housing 22 defining a cavity 24. The cavity is shaped to accommodate a detachable flashlight 26, which will be described in detail below. The cavity 24 is shaped such that when the flashlight 26 is inserted, the flashlight is removably secured to the headlamp. The flashlight and cavity are shaped such that the flashlight can preferably be inserted from the rear of the headlamp 10. Alternatively, the cavity 24 could be configured to enable the flashlight to be inserted from another direction, such as from the side or the front.

The cavity is preferably defined by a flexible plastic and is designed such that it snugly receives the flashlight. In preferred embodiments, it is partially lined with a semi-rigid plastic 28, or any other material, to provide additional structure to the cavity 24. The material used for this lining is not limited to a semi-rigid plastic, but is contemplated to be a material more rigid than the material used for the cavity. The use of the more rigid material can prevent tears in the flexible material of the cavity, maintain the general shape of the cavity, and provide a snug-fit for the flashlight. Specifically, the semi-rigid material can have a rim that engages the flashlight so that it has a snug-fit engagement. The snug-fit engagement, which will also be discussed further in detail below, removes the need for other bulky fasteners that could take more time and effort to use, especially in dark areas.

The housing 22 defining the cavity 24 preferably has a number of openings including, in one embodiment, a rear opening 30, a front opening 32, and a top opening 34 for a switch 36. In one embodiment, the flashlight is insertable through the rear opening 30. The rear opening of the cavity 24 faces the inside of the headlamp, such that the flashlight 26 may be inserted therethrough. The front opening 32 is preferably formed in the cavity to allow the light illuminated from the flashlight to shine therethrough, and is preferably smaller than the rear opening 30 to abut with a front portion of the flashlight 26 and to hold the flashlight in the cavity. The cavity 24 is preferably tapered from the rear opening 30 to the front opening 32 to allow for easy insertion of the flashlight 26, but also to prevent the flashlight from sliding all the way through. The flashlight is preferably shaped substantially the same as the shape of the cavity so that it fits snugly within the cavity.

In one embodiment of the present invention, the opening 34 is formed on the top of the housing 22 of the main body 12 to allow the switch 36 of the flashlight to protrude therethrough. This allows the switch to be accessible to the user. In other embodiments, the flexible material could allow for the activation of the switch though the material.

As best seen in FIG. 2, the cavity of the headlamp has the rear opening to allow the flashlight to be inserted, and the cavity is lined with the semi-rigid plastic 28 to better hold the flashlight in the cavity. The rear opening to the cavity has a lip 38 around the edge to also hold the flashlight in place. Also, as shown in FIG. 1 the front opening 32 of the cavity 24, which allows a front portion of the flashlight to protrude therefrom, is provided with a rim 39, formed by the semi-rigid plastic lining 28, to provide a snug-fit with a protruding portion 40 on a lens portion 43 of the removable flashlight.

The flashlight 26 is preferably an LED flashlight controlled by the switch 36. In one embodiment, the switch is located on the top of the flashlight for easy access by the user. In the alternative, the switch could be located anywhere else on the flashlight. The switch 36 may be a pushbutton that allows a user to turn the flashlight on and off, but also preferably has a dimming function. For example, from the off position, when a user presses the button once, the flashlight may be at one brightness setting, and if the user presses the switch again, the light may go to a brighter or dimmer setting. When the user presses the switch again, the light may change settings again or turn off entirely. The number of settings is not limited, nor is the direction of intensity, i.e., brighter to dimmer or dimmer to brighter.

The flashlight is such that it is fully operable without the main body and strap of the headlamp. This allows a user to operate and use the flashlight without the remainder of the headlamp device.

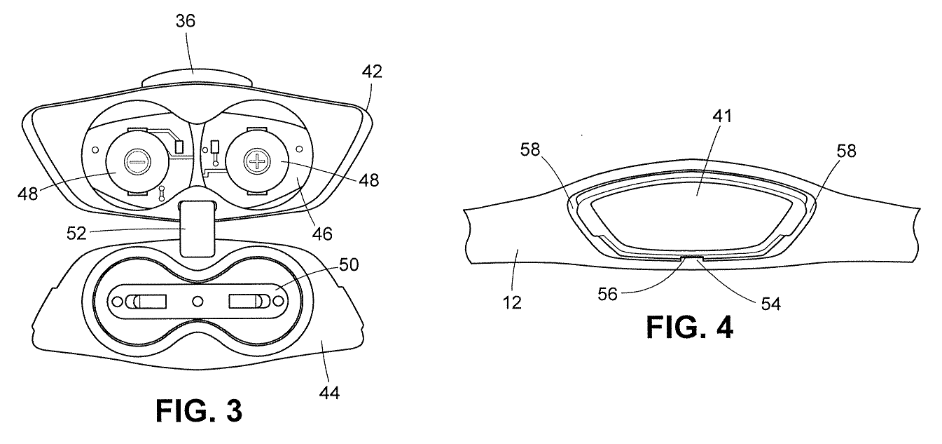

When the flashlight 26 is fully inserted in the cavity, as shown in FIG. 3, the inside of the flashlight is substantially flush with the rest of the main body so that the headlamp can fit comfortably over a user's head. The flashlight preferably has a padded portion 41, to add to a user's comfort when wearing the headlamp. The removable flashlight 26 is secured in the cavity 24 by the shape of the cavity, as well as by the features allowing for the snug-fit of the flashlight into the housing 22. When placed over a user's head, the pressure from a user's head aids in keeping the flashlight in the cavity. The flashlight is also contoured to fit comfortably on the user's head.

The flashlight 26 preferably has a body 42 and a cap 44 as shown in FIG. 3 which is a view of the flashlight with the cap detached from the body of the flashlight. The body 42 of the flashlight preferably houses a circuit board 46 comprising circuitry for the LEDs. Details of the circuitry are not discussed further herein. The body 42 of the flashlight preferably has a battery compartment 48 shaped to hold batteries (not shown). The cap 44 is preferably shaped to snugly fit with the body 42 of the flashlight and secure the batteries in place, and has a contact pad 50 to make electrical contact between the batteries. The number of batteries housed in the headlamp can be of any number. The cap 44 preferably is connected to the body by a flexible strap 52. In one embodiment of the present invention, the strap 52 is made of a flexible material. Furthermore, the strap 52 is detachable from the housing, to enable a user to completely remove the cap, if desired.

The snug-fit features of one aspect of the present invention will be described. The flashlight 26 and the housing 22 of the main body 12 are formed such that the flashlight can easily snug-fit into the housing. This enables a user to easily insert and remove the flashlight from the housing without the need for additional fasteners and the like. The housing and flashlight may preferably have various protrusions, recesses, wings, lips, flanges, rims, and projections to accomplish the snug-fit. For example, as shown in FIG. 4, the rear opening 30 of the cavity 24 has a protrusion 54 that mates with a recess 56 formed in an outer rim of the flashlight 26. The flashlight also has wings or a flange 58 that may be received behind the lip 38 formed in the rear opening of the cavity.

The rear opening 30 preferably has the lip 38 around the entire opening to hold the flashlight in place, as shown in FIG. 2. Use of a flexible material for the main body allows a user to manipulate the flexible cavity to release the flashlight therefrom.

The front portion of the flashlight 26 also has the reduced portion 40 to snug-fit with a rim 39 formed around the front opening of the housing 22.

The present invention has many advantages, including that the flashlight is securely held in a cavity of a housing of the headlamp. The flashlight is preferably snap-fit into the housing, allowing for easy insertion and removal of the flashlight from the headlamp. The flashlight is further secured in the housing when worn by a user, since the rear portion of the flashlight abuts with a user's forehead and presses the flashlight into the cavity of the main body of the headlamp. The detachable flashlight is fully operable without the headband, since the components of the flashlight are in the housing of the flashlight, enabling a user to use the flashlight without the main body and the strap.

While the present invention has been described with reference to exemplary embodiments, it is to be understood that the invention is not limited to the disclosed exemplary embodiments. The scope of the following claims is to be accorded the broadest interpretation so as to encompass modifications and equivalent structures and functions.

What is claimed is:

1. A headlamp comprising:
a strap;
a main body attached to the strap and having a housing with a cavity formed therein; and
a detachable flashlight, formed to fit in the cavity of the housing,
wherein a rear opening is formed on an inside of the main body for insertion of the detachable flashlight into the housing, and the flashlight is at least partially held in place by a user's head.

2. A headlamp according to claim 1, wherein the flashlight has at least one light emitting diode (LED).

3. A headlamp according to claim 1, wherein the flashlight has a dimming function.

4. A headlamp according to claim 1, wherein the strap is formed of a flexible material.

5. A headlamp according to claim 1, wherein the main body is formed of a flexible material.

6. A headlamp according to claim 1, wherein the detachable flashlight further comprises a body and a cap, and the cap is contoured to fit a portion of a user's head.

7. A headlamp according to claim 6, wherein the cap further comprises a padded portion designed to come in contact with a user's forehead at a portion exposed from the cavity of the housing.

8. A headlamp according to claim 1, wherein the detachable flashlight is provided with a snug-fit in the cavity of the housing.

9. A headlamp according to claim 8, wherein the flashlight has a flange to mate with a recess formed in the cavity.

10. A headlamp according to claim 5, wherein the cavity is lined with a material more rigid than the flexible material.

11. A headlamp according to claim 1, wherein the cavity has a front opening to allow light from the flashlight to shine therethrough.

12. A headlamp according to claim 1, wherein the cavity has an opening on a top portion of the cavity to allow a switch to protrude therefrom.

13. A headlamp according to claim 8, wherein the rear opening has a protrusion formed therein that mates with a recess formed in the flashlight.

14. A headlamp according to claim 8, wherein the rear opening has a lip therearound to hold the flashlight in the cavity.

15. A headlamp according to claim 14, wherein the lid of the cavity is formed to mate with wings formed on the flashlight.

16. A headlamp according to claim 1, wherein the flashlight protrudes from the headlamp when inserted into the cavity.

17. A headlamp comprising:
a housing with a cavity formed therein, the housing having a front opening and a rear opening facing an internal portion of a strap;
a flashlight formed to fit in the cavity such that the flashlight is inserted through the rear opening, and light from the flashlight projects through the front opening.

18. A headlamp according to claim 17, wherein the light is provided with a snug-fit in the cavity of the housing.

19. A headlamp according to claim 17, wherein the flashlight is trapped in the cavity of the housing by a user's forehead.

20. A headlamp according to claim 17, wherein the front opening is smaller than the rear opening, and the housing is tapered from the rear opening to the front opening.
